(19) United States
(12) Patent Application Publication
(10) Pub. No.: US 2026/0087363 A1
(43) Pub. Date: Mar. 26, 2026

(54) LARGE LANGUAGE MODEL (LLM) HALLUCINATION REDUCTION BY ADVERSERIAL PROMPT REFINEMENT

(71) Applicant: Microsoft Technology Licensing, LLC, Redmond, WA (US)

(72) Inventors: Qiang GAN, Redmond, WA (US); Chungheong GOOI, Redmond, WA (US); Chujie HE, Bellevue, WA (US); Robert Tyler Kazuo DESJARDINS, Redmond, WA (US)

(21) Appl. No.: 18/894,386

(22) Filed: Sep. 24, 2024

(51) Int. Cl. G06N 3/094; G06F 40/186; G06F 40/284; G06F 40/40; G06N 3/0475

(52) U.S. Cl. CPC G06N 3/094; G06F 40/186; G06F 40/284; G06F 40/40; G06N 3/0475

(57) ABSTRACT

Solutions disclosed herein provide for the reduction of hallucinations by language models, such as large language models (LLMs), by adversarial prompt refinement. A generator prompt template, including at least a generator prompt reference section, of a user is received from a computing device. The generator prompt template is provided as an input to a language model, the language model having an LLM-based generator, an LLM-based judger, and an LLM-based reproducer. Within the LLM-based generator, a generated response is generated from the generator prompt template. The generated response is then evaluated for a hallucination by the LLM-based judger. Based on that evaluation, a final generator prompt template is generated using an adversarial generator prompt template refinement process. For example, the adversarial generator prompt template refinement process may utilize an evolutionary prompt optimization process. The final generator prompt template, having a reduced hallucination risk, is then deployed to the LLM-based generator.

### BACKGROUND

Language models, such as large language models (LLMs), have shown remarkable performance on a variety of natural language processing such as text summarization, question answering, and natural language generation. However, while LLMs have revolutionized natural language processing and generate human-like text, LLMs still face significant challenges. One particular challenge with LLMs is their propensity to provide users with incorrect or false responses. These false or misleading responses are commonly referred to as hallucinations. Addressing the problem of LLM hallucinations has proven difficult due to the complexity and opacity of LLMs.

### SUMMARY

The disclosed examples are described in detail below with reference to the accompanying drawing figures listed below. The following summary is provided to illustrate some examples disclosed herein.

Solutions are disclosed herein which reduce hallucinations by large language models using adversarial prompt refinement. In one example, a method for reducing hallucinations is disclosed. The method includes receiving a generator prompt template of a user from a computing device, where the generator prompt template is provided as an input to a language model, and where the language model comprises a large language model (LLM) based generator, an LLM-based judger, and an LLM-based reproducer, and the NLP includes a generator prompt reference section; generating, from the generated response, a final generator prompt template, where the generation of the final generator prompt template includes evaluating the generated response for one or more hallucinations within the LLM-based judger; and based on at least the evaluation, generating the final generator prompt template using an adversarial generator prompt template refinement process; and deploying the final generator prompt template to the LLM-based generator.

### BRIEF DESCRIPTION OF THE DRAWINGS

The disclosed examples are described in detail below with reference to the accompanying drawing figures listed below:

FIG. 1 illustrates an architecture that reduces hallucinations by language models, such as large language models (LLMs);

FIG. 2 illustrates a diagram of an LLM-based generator; as may be sued in examples of the architecture of FIG. 1;

FIG. 3 illustrates a diagram of an LLM-based judger; as may be used in examples of the architecture of FIG. 1;

FIG. 4 illustrates a diagram of an LLM-based reproducer; as may be used in examples of the architecture of FIG. 1;

FIG. 5 illustrates a flowchart of a method for LLM hallucination reduction using adversarial prompt refinement; as may be implemented in examples of the architecture of FIG. 1;

FIG. 6 illustrates a flowchart of a method for LLM hallucination reduction using adversarial prompt refinement; as may be implemented in examples of the architecture of FIG. 1;

FIG. 7 illustrates a flowchart of a method for LLM hallucination reduction using adversarial prompt refinement; as may be implemented in examples of the architecture of FIG. 1;

FIG. 8 illustrates a flowchart of a method for LLM hallucination reduction using adversarial prompt refinement; as may be implemented in examples of the architecture of FIG. 1;

FIG. 9 illustrates a diagram of a neural network; as may be used in examples of the transformer network of FIG. 10, and examples of the architecture of FIG. 1;

FIG. 10 illustrates a diagram of a transformer network, as may be used in examples of the architecture of FIG. 1;

FIG. 11 illustrates a block diagram of a computing device suitable for implementing various aspects of the disclosure.

Corresponding reference characters indicate corresponding parts throughout the drawings, where practical.

### DETAILED DESCRIPTION

Solutions disclosed herein provide for the reduction of hallucinations by language models, such as large language models (LLMs), by adversarial prompt refinement. A generator prompt template, including at least a generator prompt reference section, of a user is received from a computing device. The generator prompt template is provided as an input to a language model, the language model having a large language model (LLM) based generator, an LLM-based judger, and an LLM-based reproducer. Within the LLM-based generator, a generated response is generated from the generator prompt template. The generated response is then evaluated for one or more hallucinations by the LLM-based judger. Based on that evaluation, a final generator prompt template is generated using an adversarial generator prompt template refinement process. For example, the adversarial generator prompt template refinement process may utilize an evolutionary prompt template optimization process to generate a final generator prompt template. The final generator prompt template, having a reduced risk of including hallucinations, is then deployed to the LLM-based generator. This solution reduces development time for language models for developers while also improving reliability of future responses provided to later user input sequences thereby increasing user satisfaction.

Aspects of the disclosure solve multiple problems that are necessarily rooted in computer technology and LLMs, which rely on software for proper functioning, providing computer technology that is more reliable and easier to use, by reducing the risk of incorrect information (i.e., a hallucination) being provided to a user in response to the input natural language prompts. This is accomplished, at least in part, by evaluating the response generated by the language model from a generator prompt template for hallucinations. When a hallucination is detected, the adversarial generator prompt template refinement process responds by generating one or more generations of reproduced generator prompts, each of which includes one or more mutations, each of which is then processed by the language model creating one or more generated responses. Each of the one or more generated responses is then evaluated for hallucinations with the generator prompt templates displaying improved performance selected for the next generation. This process of generation, processing, and evaluation may continue until a final generator prompt template is determined and deployed to the LLM.

Although aspects of the disclosure are described in relation to LLMs, the use of the term LLM is not intended to limit the scope of the disclosure or claims in any way, and may encompass or contemplate other language models, such as multimodal models (MMs) and the like.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

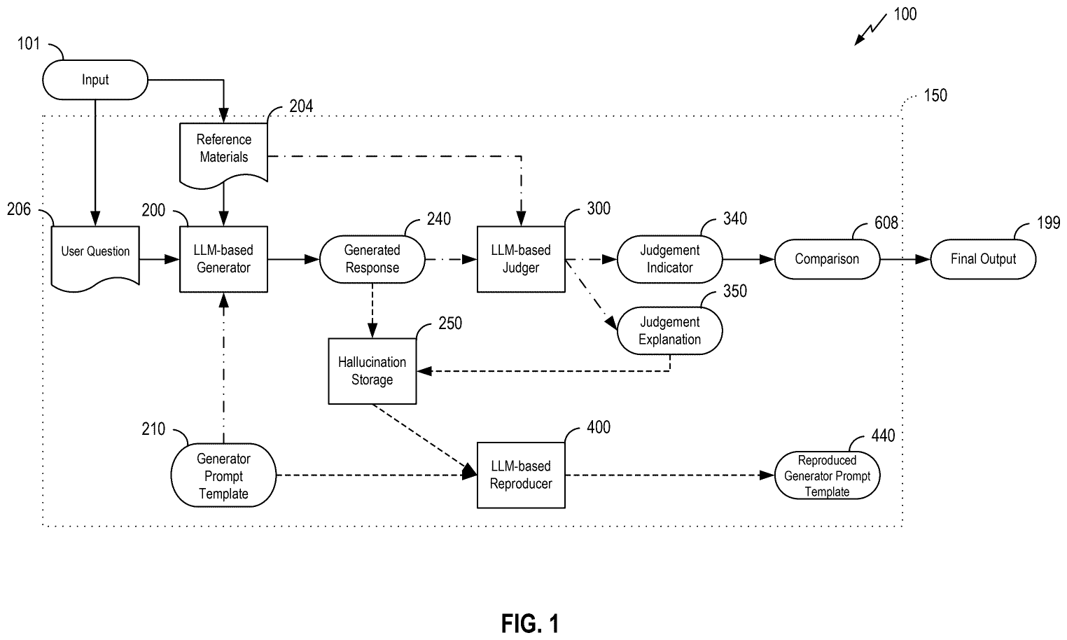

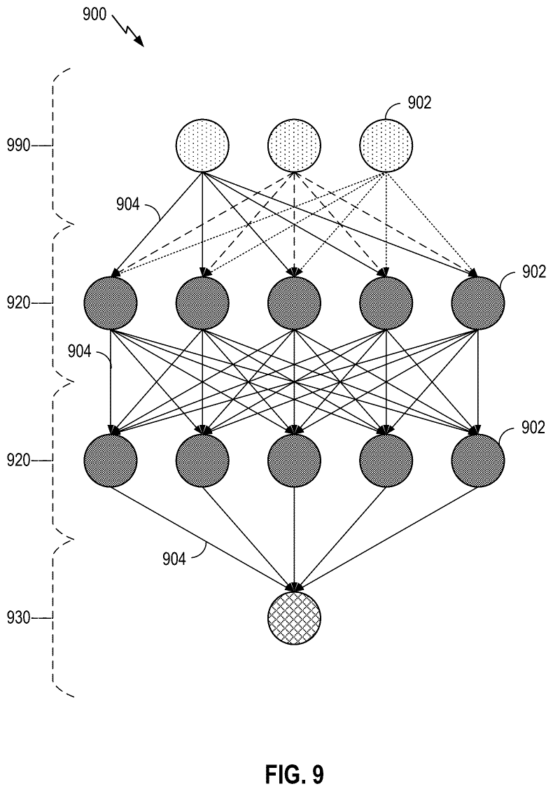

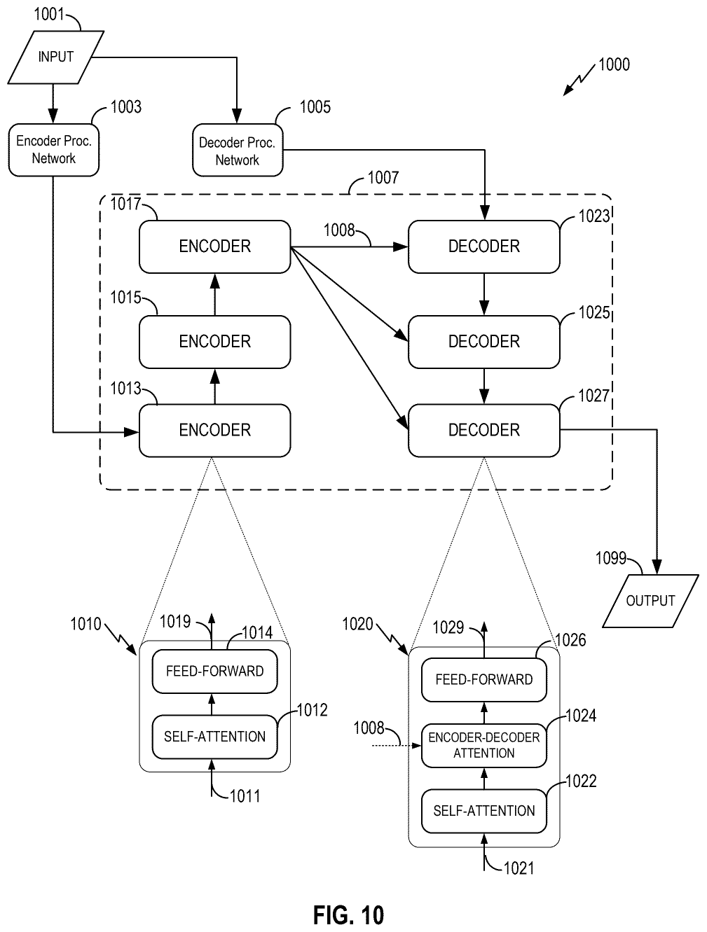

FIG. 1 illustrates a diagram of an LLM system 100 for hallucination reduction. The block diagram illustrates a simplified flowchart of the basic components of the LLM system 100 along with actions, inputs, and outputs, described in greater detail below. For ease of visualization, FIG. 1 illustrates actions moving in a single, “forward,” direction. In practice, the interactions between the components may be bidirectional, and additional internal and external connections may exist. The LLM system 100 includes an input 101, an LLM-based adversarial prompt refiner 150 which includes an LLM-based generator 200, an LLM-based judger 300, and an LLM-based reproducer 400, and a final output 199. Each component of the LLM system 100 may include one or more artificial neural networks (described below in FIG. 9) and one or more transformer networks (described below in in FIG. 10).

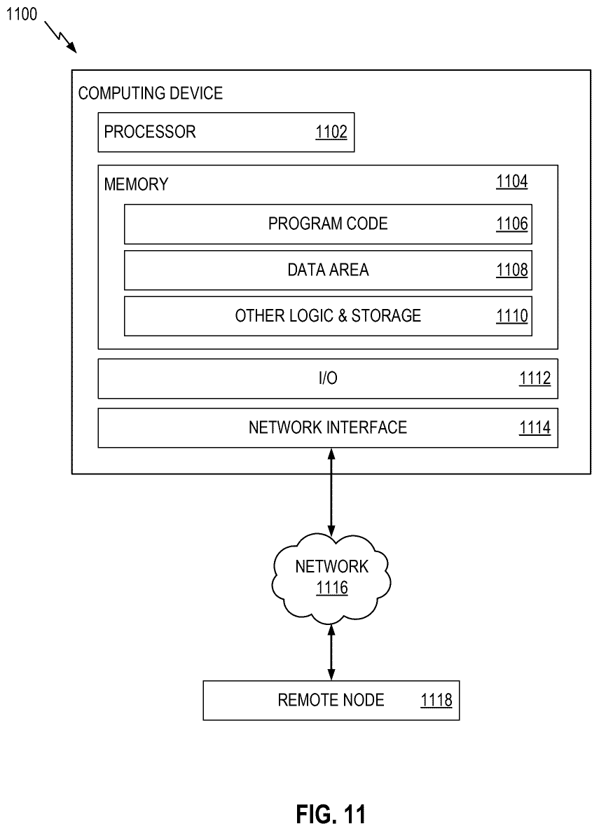

The LLM system 100 includes input 101. Input 101 is configured to accept an input sequence from an external resource. The external resource may be one or more suitable connected electronic devices including, but not limited to, an artificial neural network (ANN) 900 as described in FIG. 9, a transformer network as described in FIG. 10, a computing device 1100 as described in FIG. 11, a networked device, or similar. The input sequence 202 may include a natural language prompt, such as a user question, a user action, reference materials, or any suitable data including a series of words, characters, numbers, symbols, or any combination thereof, and deliver the input sequence 202 to the LLM-based adversarial prompt refiner 150.

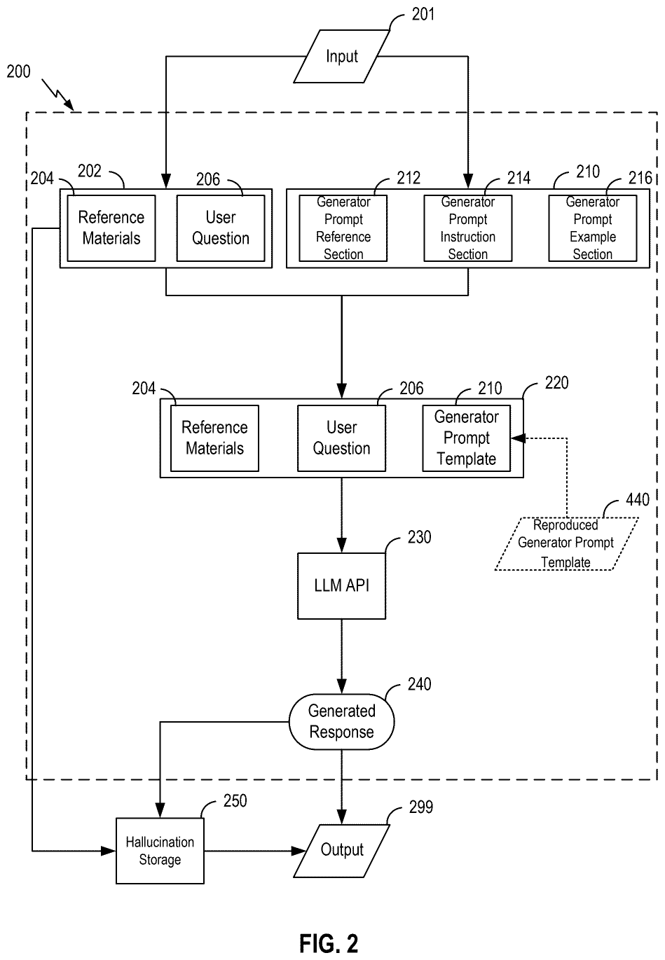

The LLM-based adversarial prompt refiner 150 includes an LLM-based generator 200, a hallucination storage 250, an LLM-based judger 300, and an LLM-based reproducer 400, shown and described in greater detail in FIGS. 2-4 below. The LLM-based adversarial prompt refiner 150 includes interconnects joining the LLM-based generator 200, hallucination storage 250, LLM-based judger 300, and LLM-based reproducer. The LLM-based adversarial prompt refiner 150 may additionally include other supporting networks (not shown) and components (not shown).

FIG. 2 illustrates a diagram of the LLM-based generator 200, which provides a portion of the LLM-based adversarial prompt refiner 150. The LLM-based generator 200 includes a generator input 201 and a generator output 299. The LLM-based generator 200 is configured to receive, at generator input 201, an input sequence 202 and a generator prompt template 210. Input sequence 202 includes a user question 206 and reference materials 204.

The generator prompt template 210 includes a generator prompt reference section 212, a generator prompt instruction section 214, and a generator prompt example section 216. In some examples, the generator prompt template 210 may include more or less than three sections. The generator prompt reference section 212 is transformed from reference materials 204. The transformation of the reference materials 204 may include extracting information from the raw reference materials and converting the raw materials into a structured format used in the generator prompt reference section 212 for consumption by the LLM-based generator 200. The generator prompt instruction section 214 may include instructions and information describing the generation task, and the generator prompt example section 216 which may contain no information, or one or more example instructions for how to generate responses to example questions following the generation task.

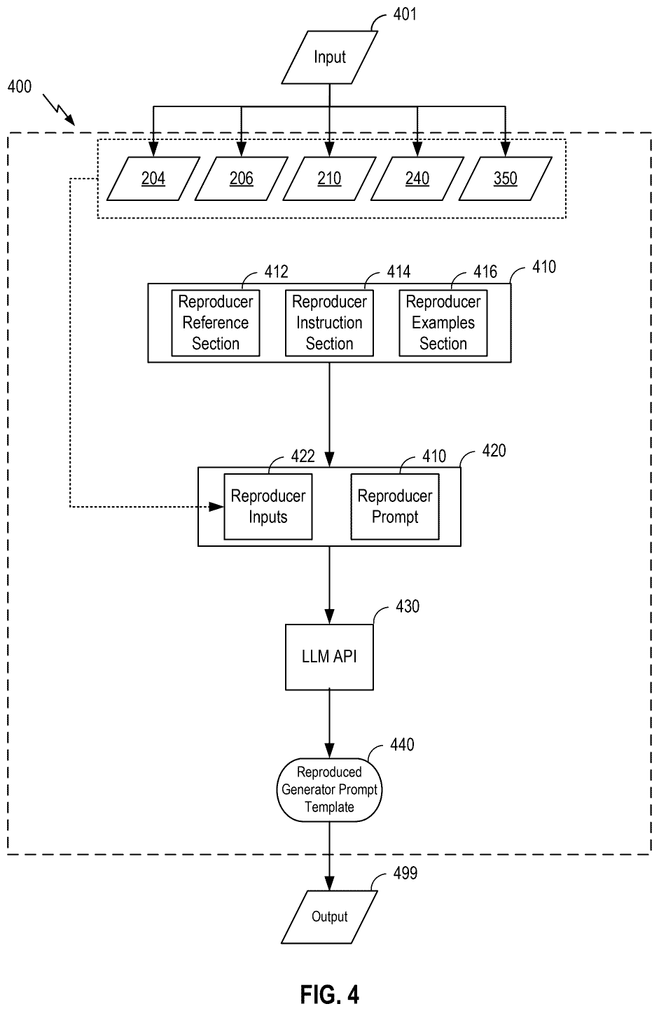

The LLM-based generator 200 then integrates the generator prompt template 210, the user question 206, and reference materials 204, into a generator instance 220. In certain cases, such as when a reproduced generator prompt template 440 (i.e., a type of generator prompt template 210 explained below in FIG. 4) is available, the LLM-based generator 200 instead integrates the reproduced generator prompt template 440, the user question 206, and reference materials 204, into the generator instance 220. The LLM-based generator 200 next sends a request to the LLM Application Protocol Interface (API) 230 to process the generator instance 220. The LLM API 230 accepts the generator instance 220, and using one or more trained models, generates a generated response 240. The LLM-based generator 200 next stores the generated response 240 in the hallucination storage 250 for later use and additionally makes the generated response 240 available at generator output 299 where it may be transmitted to the other parts of the LLM-based adversarial prompt refiner 150 and LLM system 100.

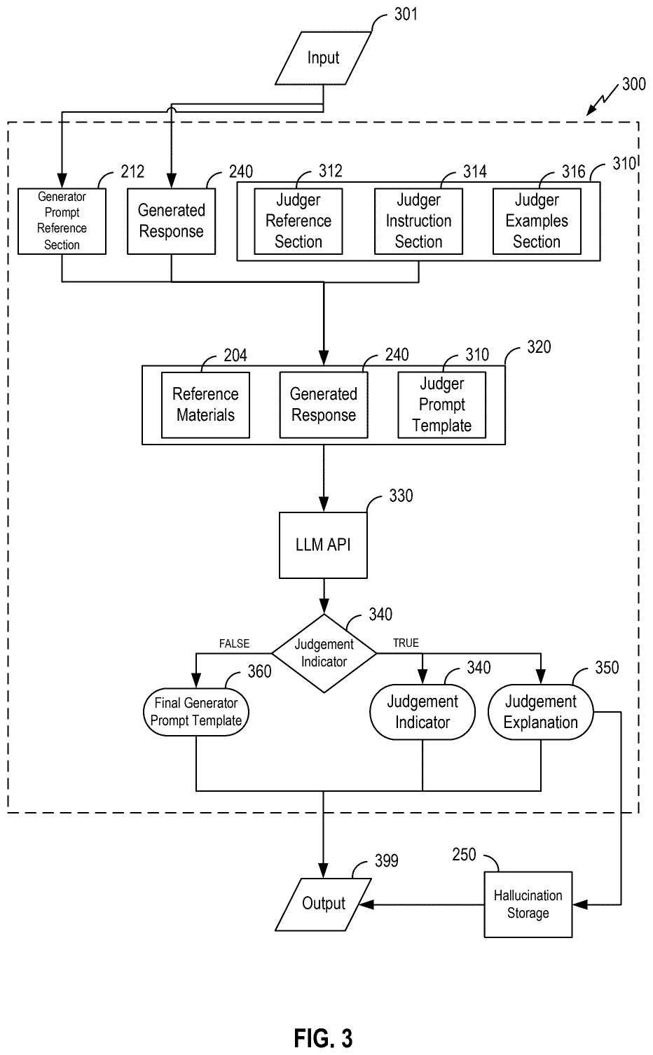

FIG. 3 illustrates a diagram of the LLM-based judger 300, a portion of LLM-based adversarial prompt refiner 150. The LLM-based judger 300 includes a judger input 301, a judger prompt template 310, and a judger output 399. The LLM-based judger 300 is configured to receive at the judger input 301, the reference materials 204, and the generated response 240. The judger prompt template 310 includes a judger reference section 312, a judger instruction section 314, and a judger examples section 316. In some examples, the judger prompt template 310 may include more or less than three sections. The judger reference section 312 is transformed from reference materials 204. The judger instruction section 314 describes a judgment task. In this example, the judgment task is to evaluate an input response for the presence of false or misleading information (i.e., a hallucination). The judger instruction section 314 includes information to assist in the judgment task such as hallucination categories, numerical limits for raw context, or other information suitable for the judgment task. The judger examples section 316 may contain no information, or one or more examples on how to detect hallucinations following the judger instruction section 314.

The LLM-based judger 300 then integrates the judger prompt template 310, reference materials 204, and the generated response 240, into a judger instance 320. The LLM-based judger 300 and sends request to an LLM Application Protocol Interface (API) 330. The LLM API 330 accepts the judger instance 320, and using one or more trained models, generates a judgment indicator 340 and a judgment explanation 350. Judgment indicator 340 indicates the presence, or absence, of a hallucination in the response input 322 based on at least the reference materials 204. The judgment indicator 340 can be a Boolean value, a fitness score, hallucination rate, or any other suitable data type. Judgment explanation 350 indicates how the LLM-based judger 300 determined whether the generated response 240 included a hallucination based on at least the reference materials 204.

Next, depending upon the judgment indicator 340, the LLM-based judger 300 may take one or more actions. For example, if the judgment indicator 340 indicates the absence of a hallucination (e.g., false), the LLM-based judger 300 transmits the generator prompt template 210 corresponding to the generated response 240 as the final generator prompt template 360 available at judger output 399. If the judgment indicator 340 indicates the presence (e.g., true) of a hallucination, for example, the LLM-based judger 300 next makes the judgment indicator 340 and the judgment explanation 350 available at judger output 399 where they may be transmitted to the other parts of the LLM-based adversarial prompt refiner 150 and LLM system 100.

In some examples, if the judgment indicator 340 for a generated response 240 is a compared to a configurable threshold value and is lesser than or equal to the configurable threshold value (e.g., a permissible hallucination rate), the LLM-based judger 300 transmits the generator prompt template 210 corresponding to the generated response 240 as the final generator prompt template 360 available at judger output 399. In other examples, if the comparison shows that judgment indicator 340 is greater than the configurable threshold value, the LLM-based judger 300 next makes the judgment indicator 340 and the judgment explanation 350 available at judger output 399 where they may be transmitted to the other parts of the LLM-based adversarial prompt refiner 150 and LLM system 100.

FIG. 4 illustrates a diagram of LLM-based reproducer 400, a portion of LLM-based adversarial prompt refiner 150. The LLM-based reproducer 400 includes a reproducer input 401, a reproducer prompt template 410, and a reproducer output 499. The LLM-based reproducer 400 is configured to receive at the reproducer input 401, the reference materials 204, the user question 206, the generator prompt template 210, the generated response, and the judgment explanation 350 (collectively referred to as reproducer inputs 422). From these inputs, the LLM-based reproducer 400 configures a reproducer prompt template 410.

The reproducer prompt template 410 includes a reproducer reference section 412, a reproducer instruction section 414, and a reproducer examples section 416. In some examples, the reproducer prompt template 410 may include more or less than three sections. The reproducer reference section 412 is transformed from reference materials 204, the user question 206, the generated response 240, and the judgment explanation 350. The reproducer examples section 416 is generated from the generator prompt template 210. The reproducer instruction section 414 describes a reproducer task. The reproducer task includes instructions, based on reference materials 204 and the judgment explanation 350, to mutate the generator prompt template 210 to avoid, or reduce the probability of, the hallucination. In one example, the instructions in the reproducer task may contain instructions to introduce one or more mutations the generator prompt instruction section 214 of the generator prompt template 210. In another example, the instructions in the reproducer task may contain instructions to introduce one or more mutations to the reproducer examples section 416 of the reproducer prompt template 410. In other examples, the reproducer task may include instructions to introduce one or more mutations the generator prompt instruction section 214, introduce one or more mutations to the reproducer examples section 416, introduce one or more mutations to the reproducer inputs 422, introduce one or more mutations to the reproducer prompt template 410, or any combination thereof. Each mutation of the one or more mutations introduced being a unique mutation.

The LLM-based reproducer 400 then integrates the reproducer prompt template 410 and the reproducer inputs 422 into a reproducer instance 420. The LLM-based reproducer 400 sends reproducer instance 420 to an LLM Application Protocol Interface (API) 430. The LLM API 430 accepts the reproducer instance 420, and using one or more trained models, generates a reproduced generator prompt template 440. The LLM-based reproducer 400 next makes a reproduced generator prompt template 440 available at reproducer output 499 where they may be transmitted to the other parts of the LLM-based adversarial prompt refiner 150 and LLM system 100.

The final output 199 of the LLM system 100 receives the final response from the LLM-based judger 300 of the LLM-based adversarial prompt refiner 150. The final output 199 is configured to transform its received input into an output sequence. The output sequence may be data, words, characters, numbers, symbols, a natural language text, or any combination thereof, suitable for output to any downstream device. For example, one or more neural networks (e.g., an LLM), a user interface (e.g., the computing device 1100 shown in FIG. 11), or any other suitable device or system.

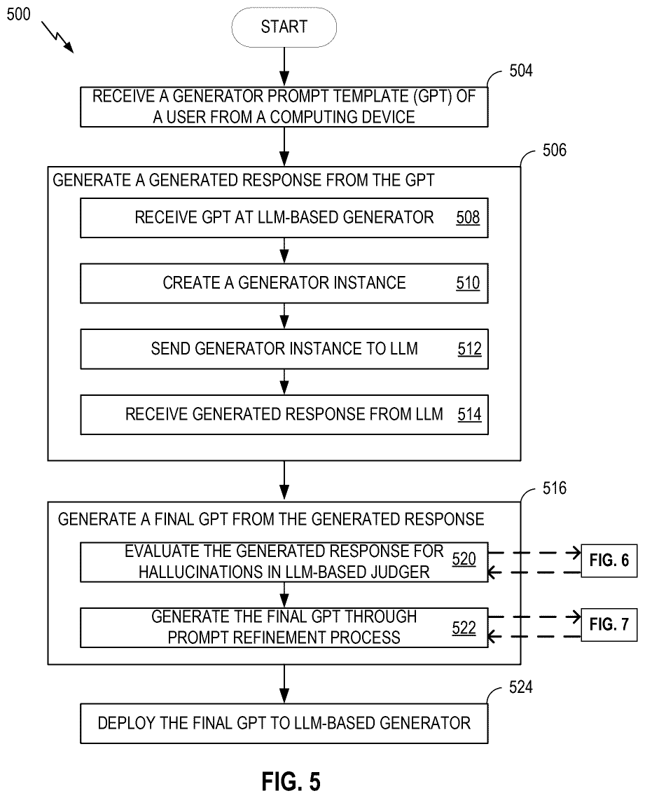

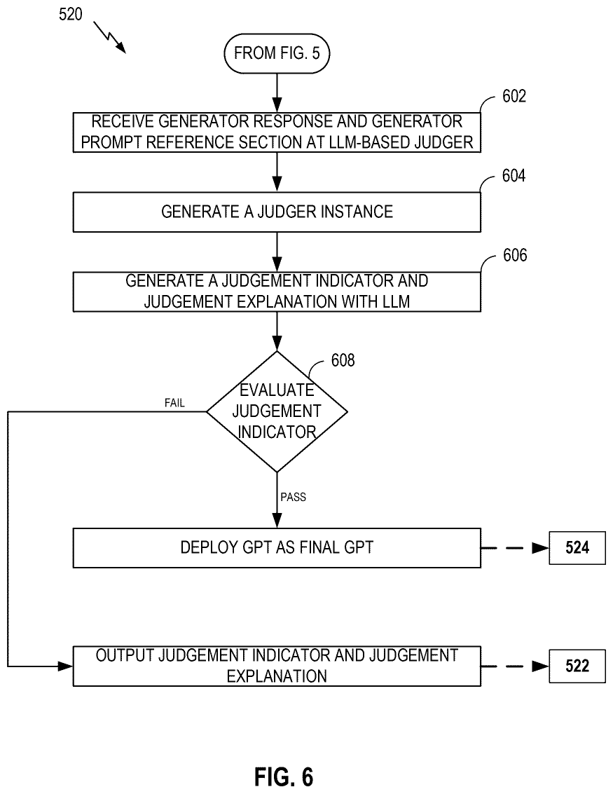

FIGS. 5-8, described below, depict flowcharts illustrating exemplary examples of operations within the LLM-based adversarial prompt refiner 150 where the LLM-based generator 300, LLM-based judger 400, and LLM-based reproducer 400, interoperate in an adversarial generator prompt template refinement process. In one example, described below in FIGS. 5-6, adversarial may mean to select a final generator prompt template based off of a generated response showing the best, or improved, performance in reducing LLM hallucinations. In another example, described below, the final generator prompt template based off of a generated response showing the best, or improved, performance in reducing LLM hallucinations where the adversarial generator prompt template refinement process includes an evolutionary prompt template optimization process. The evolutionary prompt template optimization process may be an adversarial process where an initial population, and subsequent generations, of one or more reproduced generator prompt templates “compete” against each other over successive generations to arrive at an improved, or fittest, final generator prompt template.

FIG. 5 depicts a flowchart 500 illustrating exemplary operations of LLM hallucination reduction using adversarial prompt refinement which may be performed by the LLM system 100. The operations of flowchart 500 may be performed “offline,” or “online.” In some examples, operations described for flowchart are performed by computing device 1100 of FIG. 11. For ease of understanding, the operations of flowchart 500 are described sequentially. In practice, the operations of flowchart 500 may be executed sequentially or in parallel, in order or out of order, singularly or in multiples, or any combination thereof.

Operation 504 includes receiving a generator prompt template 210 of a user from a computing device. The generator prompt template 210 includes a generator prompt reference section 212 transformed from reference materials 204, a generator prompt instruction section 214 describing the generation task, and a generator prompt example section 216 which may contain no information, or one or more example instructions for how to generate responses to example questions following the generation task. In some examples, the generator prompt template 210 may include more or less than three sections. Generator prompt template 210 is provided as an input to a Large Language Model (LLM) system, where the LLM system includes an LLM-based generator 200, an LLM-based judger 300, and an LLM-based reproducer 400.

At operation 506, the LLM-based generator 200 generates a generated response 240 from the generator prompt template 210. Operation 506 includes the four steps described above in FIG. 2. The four steps are labeled as 508, 510, 512, and 514, in FIG. 5. Step 508 includes receiving from the input 101, the generator prompt template 210, and the input sequence 202 at the LLM-based generator 200. The generator prompt template 210 includes at least three sections, a generator prompt reference section 212 transformed from reference materials 204, a generator prompt instruction section 214 describing the generation task, and a generator prompt example section 216 which may contain no information, or one or more examples on how to generate responses to example questions following the instruction. Step 510 includes creating a generator instance 220. The generator instance 220 is generated from reference materials 204, user question 206, and generator prompt template 210. In some examples, the generator instance 220 is generated from reference materials 204, the user question 206, and the reproduced generator prompt template 440. At step 512, the generator instance 220 is transmitted to the LLM API 230 for processing. At step 514, the LLM-based generator 200 receives the generated response 240 from the LLM API 230, and outputs the generated response 240 to the hallucination storage 250 and generator output 299 of the LLM-based generator.

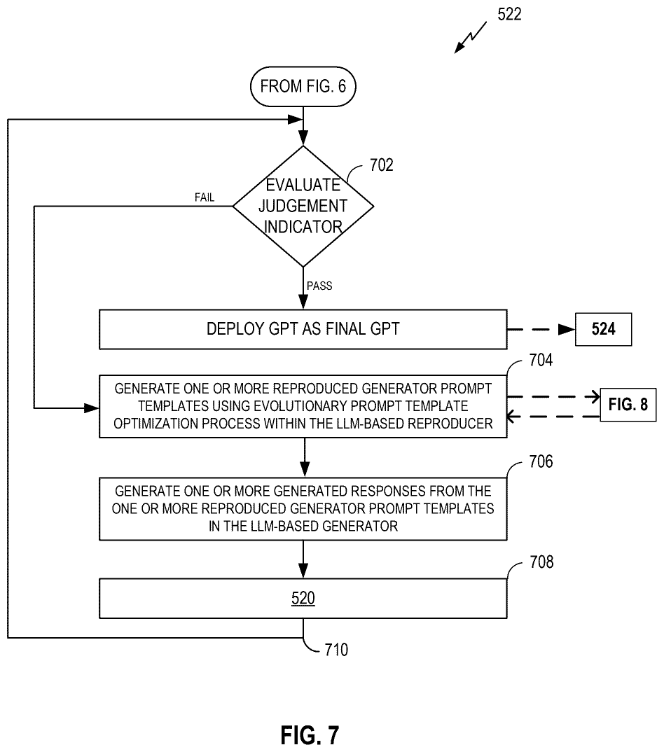

Generating a final generator prompt template 360 from the generated response 240 begins at operation 516. Generating the final generator prompt template 360 from the generated response includes operation 520 (shown in FIG. 6 and described in greater detail below), and operation 522 (shown in FIG. 7 and described in greater detail below). Operation 524 includes outputting, to the user, via computing device 1100, the final generator prompt template 360 via final output 199.

FIG. 6 depicts a flowchart illustrating the continuation of operation 520 of the flowchart 500 for LLM hallucination reduction which may be performed by the LLM system 100. Continuing from operation 520 illustrated in FIG. 5, evaluating the generated response 240 for a hallucination using the LLM-based judger 300 includes four operations, 602, 604, 608, and 610, illustrated in FIG. 6.

At operation 604, the LLM-based judger 300 generates a judger instance 320. To generate the judger instance 320, the LLM-based judger 300 integrates a judger prompt template 310, the generated response 240, and the generator prompt reference section, into the judger instance 320. The judger prompt template 310 includes at least three sections, a judger reference section 312, a judger instruction section 314, and a judger examples section 316. In some examples, the judger prompt template 310 may include less than three sections. The judger reference section 312 is transformed from reference materials 204. The judger instruction section 314 describes a judgment task. In this example, the judgment task is to evaluate an input response for the presence of false or misleading information (i.e., a hallucination). The judger instruction section 314 includes information to assist in the judgment task such as hallucination categories, numerical limits for raw context, or other information suitable for the judgment task. The judger examples section 316 may contain no information, or one or more examples on how to detect hallucinations following the instruction section.

At operation 606, the LLM-based judger 300 generates a judgment indicator 340 and a judgment explanation 350 from the judger instance 320. Generating the judgment indicator 340 and the judgment explanation 350 includes transmitting a request to an LLM API 330. The LLM API 330 accepts the judger instance 320, and using one or more trained models, generates the judgment indicator 340 and the judgment explanation 350. Judgment indicator 340 indicates the presence, or absence, of a hallucination in the response input 322 based on at least the reference materials 204. The judgment indicator 340 can be a Boolean value, a fitness score, hallucination rate, or any other suitable data type. Judgment explanation 350 indicates how the LLM-based judger 300 determined whether the response input 322 included a hallucination based on at least the reference materials 204.

At operation 608, the LLM-based judger 300 evaluates the judgment indicator 340 and takes one or more actions depending upon the judgment indicator 340. For example, if the judgment indicator 340 indicates the absence of one or more hallucinations (e.g., a pass), the LLM-based judger 300 transmits the generator prompt template 210 corresponding to the generated response 240 as the final generator prompt template 360 available at judger output 399 where flowchart 500 continues at operation 524 (shown on FIG. 5).

If the judgment indicator 340 indicates the presence (e.g., a failure) of one or more hallucinations, the LLM-based judger 300 makes the judgment indicator 340 and the judgment explanation 350 available at judger output 399 where they may be transmitted to the other parts of the LLM system 100, such as hallucination storage 250, where flowchart 500 continues at the operation 522 with generating the final generator prompt template 210 using an adversarial generator prompt template refinement process. Operation 522 continues on FIG. 7.

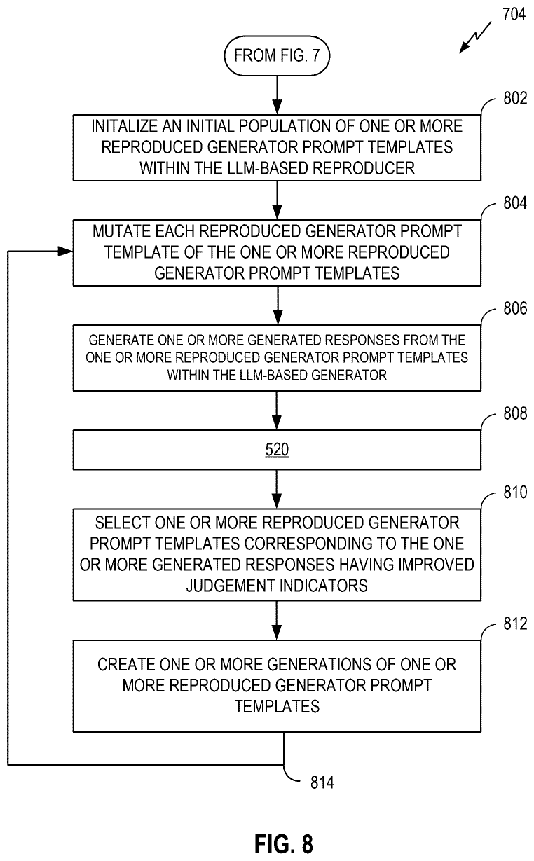

FIG. 7 depicts a flowchart illustrating the continuation of operation 522 of the flowchart 500 for LLM hallucination reduction which may be performed by the LLM system 100. The adversarial generator prompt template refinement process of operation 522 includes five operations, 702, 704, 706, 708, and 710. FIGS. 7 and 8 describe the evolutionary prompt template optimization process. The evolutionary prompt template optimization process is an adversarial process where the initial population, and subsequent generation, of the one or more reproduced generator prompt templates “compete” against each other over successive generations to arrive at an improved, or fittest, final generator prompt template.

At operation 702, which mirrors operation 608 described above, the LLM-based judger 300 compares the judgment indicator 340 to a configurable threshold value (e.g., a permissible hallucination rate). If the judgment indicator 340 is lesser than or equal to a configurable threshold value (e.g., a pass), the LLM-based judger 300 transmits the generator prompt template 210 corresponding to the generated response 240 as the final generator prompt template 360 available at judger output 399 where flowchart 500 continues at the operation 524 (shown on FIG. 5). When the judgment indicator 340 is greater than the configurable threshold value (e.g., a failure), the LLM-based judger 300 continues with the adversarial generator prompt template refinement process at operation 704.

For example, at operation 702 where a generated response 240, Generated Response A, generated from Generator Prompt Template A, has a judgement indicator 340 of 0.1 when the configurable threshold value is 0.05. In this instance, the LLM-based judger 300 would continue with the adversarial generator prompt template refinement process at operation 704.

At operation 704, the adversarial generator prompt template refinement process includes generating one or more reproduced generator prompt templates 440 using an evolutionary prompt template optimization process within the LLM-based reproducer 400. The evolutionary prompt template optimization process is described below in FIG. 8. At operation 706, one or more generated responses 240 are generated from the one or more reproduced generator prompt templates 440 generated in operation 704 within the LLM-based generator 200.

At operation 708, each generated response 240 of the one or more generated responses 240 proceeds to operation 520 (shown in FIG. 5) where a judgment indicator 340 is generated for each generated response 240 of the one or more generated responses 240 and then compared against the configurable threshold value. Operations 702, 704, 706, and 708 repeat during operation 710 until a judgment indicator 340 is equal to or lesser than the configurable threshold value or the evolutionary prompt template optimization process is terminated.

For example, at operation 710, the prior operations 702, 704, 706, 708, and operations described in FIG. 8 below, would repeat until some Generated Response X, generated from some Generator Prompt Template X, or Reproduced Generator Prompt Template X, has a judgement indicator 340 less than the configurable threshold value is 0.05. At that point, Generator Prompt Template X, or Reproduced Generator Prompt Template X, corresponding to Generated Response X, would be deployed as the final generator prompt template 360.

FIG. 8 depicts a flowchart illustrating the evolutionary prompt template optimization process (EPOP) of operation 704 illustrated in FIG. 7. The EPOP illustrated in FIG. 8 includes seven operations, 802, 804, 806, 808, 810, 812 and 814.

At operation 802, an initial population of one or more reproduced generator prompt templates 440 based on at least the generator prompt template 210 are initialized in the LLM-based reproducer 400. For example, if the generator prompt template 210 was Generator_Prompt_Template 1, the initial population, or first generation, (e.g., Generation A) of one or more reproduced generator prompt templates 440 are initialized in the LLM-based reproducer 400 may include, Reproduced_Generator_Prompt_Templates 1A, 2A, and 3A.

During the initialization of the initial population, or subsequent reproduced generator prompt templates 440 of the one or more reproduced generator prompt templates 440, the LLM-based reproducer 400 introduces one or more unique mutations into each reproduced generator prompt template 440 at operation 804. Continuing from the example above, after operation 804, the LLM-based reproducer 400 may introduce unique mutations M1, M2, and M3, to Reproduced_Generator_Prompt_Templates JA, 2A, and 3A, resulting in Reproduced_Generator_Prompt_Templates 1A(M1), 2A(M2), and 3A(M3).

At operation 806, the EPOP generates one or more generated responses 240 within the LLM-based generator 200 from the one or more reproduced generator prompt templates 440. Each of the generated responses 240 corresponds to a reproduced generator prompt template 440. Continuing from the example above, after operation 806, the LLM-based generator 200 may generate Generated Responses 1A, 2A, and 3A, each respectively generated from Reproduced_Generator_Prompt_Templates 1A(M1), 2A(M2), and 3A(M3).

At operation 808, a judgment indicator 340 is generated in the LLM-based judger 300 for each generated response 240 of the one or more generated responses 240 and compared against the configurable threshold value as described in operation 520 (shown in FIG. 5.) Continuing from the example above, after operation 806, the LLM-based judger 300 may generate Judgement_Indicator 1A, 2A, and 3A, each generated from Generated Responses 1A, 2A, and 3A, and having a judgement indicator 340 value of 0.9, 0.8, and 0.7, respectively. In this example, Judgement_Indicator 1A, 2A, and 3A, are all greater than the configurable threshold value 0.1.

After which, the one or more of the reproduced generator prompt templates 440 which correspond to the one or more generated responses 240 which have an improved (e.g., better, best, or highest) judgment indicators 340 are selected in operation 810. For example, continuing from the example above, Reproduced_Generator_Prompt_Template 3A(M3) corresponding to the Generated Response 3A having a Judgement_Indicator 3A, having a value of 0.7 is selected as having an improved judgment indicator 340.

From the selected one or more reproduced generator prompt templates 440 corresponding to the one or more generated responses 240 having the improved judgment indicators, one or more generations of one or more reproduced generator prompt templates 440 are created in operation 812 by the LLM-based reproducer 400. Continuing from the example above, from Reproduced_Generator_Prompt_Template 3A(M3), subsequent generations (e.g., Generations B, C, . . . ) of one or more reproduced generator prompt templates 440 are created by the LLM-based reproducer, each including one or more unique mutations (e.g., M1, M2, . . . )

Operations 804, 806, 808, 810, 812, and operations described in FIG. 7 above, would repeat during operation 814 a judgment indicator 340 is equal to or lesser than the configurable threshold value. For example, operation 814 may continue until some Generated_Response X, generated from some Generator Prompt Template X, or Reproduced_Generator_Prompt_Template X, has a judgement indicator 340 less than the configurable threshold value is 0.05. At that point, Generator Prompt Template X, or Reproduced_Generator_Prompt_Template X, corresponding to Generated_Response X, would be deployed as the final generator prompt template 360.

In some examples, rather than repeating operations 804, 806, 808, 810, and 812, during operation 814 until the judgment indicator 340 is equal to or lesser than the configurable threshold value, operation 814 terminates the repetition of operations 804, 806, 808, 810, and 812, for a configurable number of generations. For example, between about 1-5 generations, between about 6-10 generations, between about 11-20 generations, between about 21-40 generations, between about 41 to 99 generations, or 100 or more generations. When the configurable number of generations has been met, the generated response 240 corresponding to the improved judgment indicator 340 is selected and output as the final generator prompt template 360.

In other examples, when creating each generation of the one or more reproduced generator prompt templates 440, operation 810 instead organizing the reproduced generator prompts into pairs and exchanging an attribute (e.g., reproducer reference section 412, reproducer instruction section 414, reproducer examples section 416), attributes, or portion of an attribute, between the two reproduced generator prompt templates 440 of each pair.

FIG. 9 illustrates an artificial neural network (ANN) 900. Typically, an ANN is organized into layers with each layer performing a different transformation of its received input signals. A typical layer organization may include an input layer, one or more hidden layers, and an output layer. As shown in FIG. 9, ANN 900 includes four layers, an input layer 990, two hidden layers 920, and an output layer 930.

Each layer of ANN 900 consists of nodes 902, interconnected by edges 904. In ANN 900, input layer 990 includes three nodes 902, each hidden layer 920 includes five nodes 902, and the output layer 930 includes one node. The three nodes 902 of input layer 990 are each connected to each of the five nodes of the first hidden layer 920 by edges 904. Each of the five nodes 902 in the first hidden layer 920 are connected by edges 904 to each of the five nodes 902 of the second hidden layer 920. Each of the five nodes 902 in the second hidden layer 920 are connected to the single node 902 of the output layer 930.

Each node 902 of ANN 900 receives input signals, typically made of real numbers, from one or more connected nodes 902 via one or more edges 904. The node 902 then processes the received input signal using a transformation function and transmits result as an output signal to one or more connected nodes 902 via one or more edges 904. The strength of the signal at each connection is determined by a weight which is adjusted during a training process. Training an ANN traditionally involves inputting labeled training data to the ANN to iteratively update the parameters of the ANN, such as edge 904 weights, to minimize some defined loss function.

ANNs, such as ANN 900, come in a variety of types including, but not limited to, feedforward (e.g., group method, autoencoder, probabilistic, time delay, convolutional, deep stacking, tensor, tensor deep stacking), radial basis function, general regression, deep belief, recurrent (e.g., fully recurrent, Hopfield, Boltzmann, self-organizing, learning vector, simple recurrent), reservoir computing, echo state, bidirectional, stochastic, genetic scale, modular (e.g., associative, machine committee), physical (e.g., ADALINE memristor, and optical), dynamic (e.g., cascading, neuro-fuzzy, compositional pattern-producing), memory-based (e.g., one-shot associative, hierarchical temporal, holographic associative, long short-term memory), encoder-decoder, decoder only, instantaneously trained, spiking, spatial, neocognitron, compound hierarchical-deep, deep predictive coding, multilayer kernel, transformers, and others.

FIG. 10 illustrates a diagram of a transformer network 1000. Transformer networks, such as transformer network 1000, are a type of neural network architecture primarily used in natural language processing models, such as Large Language Models (LLMs). Transformer networks offer some advantages over other neural network architectures, such as the ability to process the entire data input (e.g., a natural language prompt) all once rather than piecemeal. A transformer network, such as the transformer network 1000 shown in FIG. 10 includes at least an input 1001, an encoder processing network 1003, an output processing network 1005, an encoder-decoder stack 1007 including one or more encoders 1010 and one or more decoders 1020, and an output 1099 layer.

Transformer network 1000 includes input 1001. Input 1001 is connected to the encoder processing network 1003 and the output processing network 1005. Input 1001 is configured to accept an input sequence. The input sequence may be a natural language prompt made of a series of words, characters, numbers, symbols, or any combination thereof, from any suitable input device, (e.g., the computing device 1100 shown in FIG. 11), and deliver the NLP to the encoder processing network 1003 and the output processing network 1005.

Transformer network 1000 includes an encoder processing network 1003. The encoder processing network 1003 includes one or more embedding layers (not shown) and one or more position encoding layers (not shown). The encoder processing network 1003 is configured to accept an input sequence from input 1001, perform work on the input sequence (i.e., input embedding), and output one or more embedded input matrices representing the processed input sequence to the encoder-decoder stack 1007.

The one or more embedding layers of the encoder processing network 1003 map each input token (e.g., word, sub-word, or character) of the input sequence to a word identifier (ID). The word IDs are next converted into a fixed-size vector. The conversion to a fixed-size encoding vector is achieved through a learned embedding matrix, where each row corresponds to the embedding of a unique token for each word ID in the learned embedding matrix. For example, if the input sequence consists of tokens [t₁, t₂, . . . , tₙ], the one or more embedding layers maps the tokens to encoding vectors [e₁, e₂, . . . , eₙ].

The one or more position encoding layers of the encoder processing network 1003 map each input token of the input sequence to one or more position encoding (PE) vectors. The one or more position encoding layers operate independently of the one or more embedding layers. Each position encoding is a fixed value that depends only upon the max length of the input sequence. The position encodings may be computed by using sine and cosine functions,

$${PE}_{( pos , 2 i )} = sin ( \frac{pos}{{10000}^{2 i / d} model} ) , \\ and \qquad ( Eq . 1 )$$

$${PE}_{( pos , 2 i + 1 )} = cos ( \frac{pos}{{10000}^{2 i / d} model} ) \qquad ( Eq . 2 )$$

where pos is the position of the token in the input sequence, i is the index value of the position vector, and d_{model} is the length of the encoding vector.

Lastly, the one or more embedding layers of the encoder processing network 1003 add the one or more encoding vectors and one or more position vectors, [e₁+PE_{1,e2}+PE₂, . . . , eₙ+PEₙ], to create one or more embedded input matrices (e.g., input embeddings) which are then output the encoder-decoder stack 1007.

Transformer network 1000 includes a decoder processing network 205. The decoder processing network 205 includes one or more embedding layers (not shown) and one or more position encoding layers (not shown). The decoder processing network 205 is configured to accept an input sequence from input 1001, perform work on the input sequence (i.e., output embedding), and output one or more embedded output matrices representing the processed input sequence to the encoder-decoder stack 1007. The decoder processing network 205 operates in a comparable manner to the encoder processing network 1003 described above with one key difference. Before output embedding, the input sequence has its data shifted one position to the right and has a start token insert in its first position.

Transformer network 1000 includes an encoder-decoder stack 1007. The encoder-decoder stack 1007 includes one or more encoders 1010 and one or more decoders 1020. In the transformer network 1000 illustrated in FIG. 2, there are three encoders 1010, a first encoder 1013, a second encoder 1015, and a third encoder 1017, and three decoders 1020, a first decoder 1023, a second decoder 1025, and a third decoder 1027.

The one or more encoders 1010 each include an encoder input 1011 and an encoder output 1019. Each encoder input 1011 may be connected to the output of the encoder processing network 1003, one or more encoder outputs 1019, or to one or more decoder inputs 1021. The one or more decoders 1020 each include a decoder input 1021 and a decoder output 1029. Each decoder input 1021 may be connected to one or more encoder outputs 1019, one or more decoder inputs 1021, one or more decoder outputs 1029, an output processing network 1005, or the output 1099.

The transformer network 1000 shown in FIG. 10 includes three encoders 1010, a first encoder 1013, a second encoder 1015, and a third encoder 1017, arranged in a stack (e.g., daisy chain) configuration allowing each successive encoder 1010 to build upon the output of the previous encoder 1010. Each of the encoders 1010 in the transformer network 1000 may include multiple layers of interconnected neural networks. Each of the encoders may include skip-connections, normalization layers, or other layers not shown in FIG. 2. Each of the encoders 1010 include at least one self-attention network (SAN) 1012 and at least one feed-forward network (FFN) 1014, each of which may include multiple layers of interconnected neural networks.

In transformer network 1000, the output of the encoder processing network 1003 is connected to the encoder input 1011 of the first encoder 1013. The encoder output 1019 of the first encoder 1013 is connected to the encoder input 1011 of the second encoder 1015. The encoder output 1019 of the second encoder 1015 is connected to the encoder input 1011 of the third encoder 1017, and the encoder output 1019 of the third encoder 1017 is connected to each of the decoder inputs 1021 of the one or more decoders 1020.

In operation, the encoder input 1011 of the first encoder 1013 receives the embedded input matrices from the output of the encoder processing network 1003. Internally, SAN 1012 of the first encoder 1013 accepts the embedded input matrices and generates one or more Context Vectors (CVs). Each of the CVs contains a latent vector representation capturing the different contextual relationships between the sequence and position of the words that originally formed an embedded input matrix. This process of contextualization is commonly referred to as attention, or self-attention.

For each CV, the SAN 1012 first transforms the embedded input matrix into three vectors, a Query Vector (QV), a Key Vector (KV), and a Value Vector (VV). Each of the three vectors is computed using learned weight matrices as shown in the equations:

$$QV = {XW}^{Q} , KV = {XW}^{K} , VV = {XW}^{V} \qquad ( Eq . 3 )$$

where X is the input embedding, and W^{Q}, W^{K}, and W^{V}, represent learned value matrices.

Second, an Attention Score (e.g., relevance) is computed. The Attention Scores represent how much focus each position in the embedded input matrix sequence should have on other positions of the sequence. The Attention Score is be computed using the scaled dot product of the QV of one position in the sequence with the KVs of all the positions, followed by a scaling factor via the equation,

$$Attention Score ( Q , K , V ) = softmax ( \frac{Q \cdot {K}^{T}}{\sqrt{{d}_{k}}} ) V \qquad ( Eq . 4 )$$

where Q is the QV for a particular position, K contains the KVs for all positions, V contains the VVs for all positions, and dₖ is the dimension of the KVs. During the second step, masking is utilized to zero out any padding in the input sequences to ensure that any padding does not contribute to the self-attention process.

In the third step, weighted sums of the VVs are computed. A calculated weighted sum is the Context Vector (CV) for a particular position in the sequence,

$$Context Vector = {\sum }_{i} ( Attention {Score}_{i} \times {VV}_{i} ) \qquad ( Eq . 5 )$$

where VVᵢ is each VV of the VVs weighted by the Attention Score corresponding to its position, Attention Scoreᵢ. To capture the differing aspects of the relationships between the positions of the sequence, multiple sets (e.g., heads) of Q, K, and V matrices and CVs are generated. The CVs of the multiple heads are concatenated and linearly transformed,

$$Multi - Head Output = Concat ( {head}_{1} , {head}_{2} , … , {head}_{h} ) {W}^{0} \qquad ( Eq . 6 )$$

where W⁰ is a learned weight matrix, to create the SAN 1012 final output. the SAN 1012 final output is subsequently passed to the feed-forward network 1014 of the first encoder 1013.

The FFN 1014 assists in transforming the SAN 1012 final outputs into more useful representations for the modeling task at hand. The feed-forward network (FFN) 1014 of the first encoder 1013 is applied to each position of the SAN 1012 final output independently and identically to generate a FFN 1014 final output. The FFN 1014 may include one or more neural network layers with a rectified linear unit (ReLU) function in between,

$$FFN ( x ) = max ( 0 , {xW}_{1} + {b}_{1} ) {W}_{2} + {b}_{2} \qquad ( Eq . 7 )$$

where W₁ and W₂ are weight matrices and b₁ and b₂ are bias vectors.

By introducing non-linearity through activation functions such as the ReLU function above, the FFN 1014 enables the first encoder 1013, and subsequent encoders of the one or more encoders including the second encoder 1015 and the third encoder 1017 of the encoder-decoder stack 207 to model more complex patterns and relationships in the input NLP. The FFN 1014 final output is connected to the encoder output 1019 of the first encoder 1013.

The second encoder 1015 accepts the output of the first encoder 1013 at its encoder input 1011 as an input. The second encoder 1015 processes the input as described above and outputs the result from its encoder output 1019 to the encoder input 1011 of the third encoder 1017. The third encoder 1017 processes the input as described above and outputs the result from its encoder output each decoder input 1021 of the one or more decoders 1020.

The encoder-decoder stack 1007 includes one or more decoders 1020. In this example, the encoder-decoder stack 1007 includes three decoders 1020, a first decoder 1023, a second decoder 1025, and a third decoder 1027, arranged in a stack (e.g., daisy chain) configuration. In transformer network 1000, the decoder inputs 1021 of the first decoder 1023, the second decoder 1025, and the third decoder 1027, are connected by interconnects 1008 to the encoder output 1019 of the third encoder 1017. The decoder output 1029 of the first decoder 1023 is connected to the decoder input 1021 of the second decoder 1025. The decoder output 1029 of the second decoder 1025 is connected to the decoder input 1021 of the third decoder 1027, and the decoder output 1029 of the third decoder 1027 is connected to output 1099.

Each decoder 1020 may include skip-connections, normalization layers, or other layers not shown in FIG. 2. Each decoder 1020 includes at least a self-attention network (SAN) 1022, at least an encoder-decoder-attention network (EDAN) 1024, and at least a feed-forward network (FFN) 1026, each of which (SAN 1022, EDAN 1024, FFN 1026) may include multiple layers of interconnected neural networks.

In operation, the decoder input 1021 of the first decoder 1023 receives the embedded target matrices from the output of the decoder processing network 205. Internally, SAN 1022 of the first decoder 1023 accepts the embedded target matrices and generates one or more Target Context Vectors (TCVs). The SAN 1022 operates in a comparable manner as the SAN 1012 described above, but operates on a different input, the embedded target matrices, and outputs TCVs to the EDAN 1024 of the first decoder 1023.

EDAN 1024 of the first decoder 1023 operates in a comparable manner as SAN 1022 with a key difference. The EDAN 1024 receives as input, the output from SAN 1022 and the output of the third encoder 1017. The EDAN is therefore getting a representation of the target sequence from the first decoder 1023, SAN 1022, and a representation of the input sequence from the output of the third encoder 1017. From this, the EDAN 1024 computes attention scores in an analogous manner as described above with the attention scores for each position of the sequence capturing the influence of the attention scores of each position of the input sequence. The output of the EDAN 1024 of the first decoder 1023 is then passed to the FFN 1026 of the first decoder 1023 which operates in an analogous manner as FFN 1016 described above.

The resulting output of FFN 1026 of the first decoder 1023 is then transmitted from the decoder output 1029 of the first decoder 1023. The second decoder 1025 accepts the output of the first decoder 1023 at its decoder input 1021 as an input. The second decoder 1025 processes the input as described above and outputs the result from its decoder output 1029 to the decoder input 1021 of the third decoder 1027. The third decoder 1027 processes the input as described above and outputs the result from its decoder output 1029 to the transformer network output 1099.

The output 1099 of the transformer network 1000 receives the result of the third decoder's 1027 decoder output 1029. The output 1099 is configured to transform its received input into an output sequence. The output sequence may be data, words, characters, numbers, symbols, a natural language text, or any combination thereof, suitable for output to any downstream device. For example, one or more neural networks (e.g., an LLM), a user interface (e.g., the computing device 1100 shown in FIG. 11), or any other suitable device or system.

FIG. 11 illustrates a block diagram of a computing device. Computing device 1100 that may be used as any component described herein that may require computational or storage capacity. Computing device 1100 has at least a processor 1102 and a memory 1104 that holds program code 1106, data area 1108, and other logic and storage 1110. Memory 1104 is any device allowing information, such as computer executable instructions and/or other data, to be stored and retrieved. For example, memory 1104 may include one or more random access memory (RAM) modules, flash memory modules, hard disks, solid-state disks, persistent memory devices, and/or optical disks. Program code 1106 comprises computer executable instructions and computer executable components including instructions used to perform operations described herein. Data area 1108 holds data used to perform operations described herein. Memory 1104 also includes other logic and storage 1110 that performs or facilitates other functions disclosed herein or otherwise required of computing device 1100. An input/output (I/O) component 1112 facilitates receiving input from users, developers, and other devices and generating displays for users, developers, and outputs for other devices. A network interface 1114 permits communication over external computer network 1116 with a remote node 1118, which may represent another implementation of Computing device 1100, LLM system 100, or any compatible electronic device or interface.

Although described in connection with an example computing device 1100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for LLM hallucination reduction, comprising:
a memory containing computer-readable instructions executable by a processor; and
a Large Language Model (LLM) system implemented at the processor, comprising:
an LLM-based adversarial prompt refiner configured to generate a final generator prompt template using an adversarial generator prompt template refinement process, the LLM-based adversarial prompt refiner comprising:
an LLM-based generator configured to receive a generator prompt template of a user from a computing device, wherein the generator prompt template includes at least a generator prompt reference section, and generate one or more generated responses from the generator prompt template or one or more reproduced generator prompt templates,
an LLM-based judger configured to generate a judgment indicator indicating a presence or an absence of one or more hallucinations for each generated response of the one or more generated responses, compare each judgement indicator with a configurable threshold value, and deploy the final generator prompt template, wherein the final generator prompt template is based on at least the generator prompt template or reproduced generator prompt template corresponding to the generated response of the one or more generated responses having the judgment indicator lesser than or equal to the configurable threshold value; and
an LLM-based reproducer configured to, in response to the judgement indicator comparison, generate one or more reproduced generator prompt templates.

2. The system of claim 1, wherein evaluating each generated response of the one or more generated responses for one or more hallucinations within the LLM-based judger comprises:
accepting as inputs at the LLM-based judger, the generated response, and the generator prompt reference section;
generating a judger instance from the inputs and a judger prompt template; and
generating from the judger instance, a judgment indicator, and a judgment explanation, wherein the judgment indicator indicates a presence or an absence of one or more hallucinations in the generated response, wherein the judgment explanation indicates how the LLM-based judger determined whether the generated response included a hallucination, and wherein the judgment explanation is based on at least the generator prompt reference section.

3. The system of claim 1, wherein the adversarial generator prompt template refinement process further comprises an evolutionary prompt template optimization process, the evolutionary prompt template optimization process comprising:
initializing an initial population of one or more reproduced generator prompt templates within the LLM-based reproducer, wherein the initial population of one or more reproduced generator prompt templates is generated from the generator prompt template, and wherein each reproduced generator prompt template of the initial population includes one or more mutations;
generating within the LLM-based generator from the initial population of one or more reproduced generator prompt templates, one or more generated responses, wherein each generated response of the one or more generated responses corresponds to each reproduced generator prompt template of the one or more reproduced generator prompt templates;
generating a judgment indicator within the LLM-based judger for each generated response the one or more generated response;
comparing each judgment indicator against the configurable threshold value;
selecting one or more reproduced generator prompt templates corresponding to the one or more generated responses having an improved judgment indicators; and
creating one or more generations of one or more reproduced generator prompt templates until a judgment indicator is equal to or lesser than the configurable threshold value.

4. The system of claim 3, wherein the creating of each generation of the one or more generations comprises repeating a series of operations, the series of operations comprising:
reproducing the selected one or more reproduced generator prompt templates, wherein each reproduced generator prompt template of one or more reproduced generator prompt templates includes a one or more mutations;
generating the judgment indicator for each reproduced generator prompt template of the one or more reproduced generator prompt templates, wherein each judgment indicator is based on at least the generated response for each reproduced generator prompt template;
selecting one or more reproduced generator prompt templates having an improved judgment indicator;
comparing the judgment indicator against the configurable threshold value; and
based on at least the comparison, terminating the series of operations when the judgment indicator for a generated response is equal to or lesser than the configurable threshold value;
selecting a generated response having the judgment indicator equal to or lesser than the configurable threshold value; and
outputting the final generator prompt template, wherein the final generator prompt template is the selected generated response.

5. The system of claim 4, wherein each mutation of the one or more mutations comprise at least one unique mutation.

6. The system of claim 4, wherein creating each generation of the one or more generations of reproduced generator prompts further comprises:
terminating the series of operations after a configurable number of generations;
selecting a generated response having an improved judgment indicator; and
outputting the final generator prompt template, wherein the final generator prompt template is the reproduced generator prompt template corresponding to the selected generated response.

7. The system of claim 4, wherein creating each generation of the one or more generations of reproduced generator prompts further comprises:
organizing the one or more reproduced generator prompt templates into pairs; and
exchanging an attribute between each reproduced generator prompt template of each pair.

8. A method for hallucination reduction, comprising:
receiving a generator prompt template of a user from a computing device as an input to a Large Language Model (LLM), wherein the generator prompt template includes at least a generator prompt reference section, and wherein the LLM comprises an LLM-based adversarial prompt refiner configured to generate a final generator prompt template using an adversarial generator prompt template refinement process, the adversarial generator prompt template refinement process comprising:
generating within an LLM-based generator, one or more generated responses from the generator prompt template or reproduced generator prompt templates;
generating within an LLM-based judger, a judgment indicator indicating a presence or an absence of one or more hallucinations for each generated response of the one or more generated responses;
comparing within the LLM-based judger, each judgement indicator with a configurable threshold value;
deploying from the LLM-based judger, the final generator prompt template, wherein the final generator prompt template is based on at least the generator prompt template or reproduced generator prompt template corresponding to the generated response of the one or more generated responses having the judgment indicator lesser than or equal to the configurable threshold value; and
generating one or more reproduced generator prompt templates, within an LLM-based reproducer, in response to the judgement indicator comparison.

9. The method of claim 8, wherein evaluating each generated response of the one or more generated responses for one or more hallucinations within the LLM-based judger comprises:
accepting as inputs at the LLM-based judger, the generated response, and the generator prompt reference section;
generating a judger instance from the inputs and a judger prompt template; and
generating from the judger instance, a judgment indicator, and a judgment explanation, wherein the judgment indicator indicates a presence or an absence of one or more hallucinations in the generated response, wherein the judgment explanation indicates how the LLM-based judger determined whether the generated response included a hallucination, and wherein the judgment explanation is based on at least the generator prompt reference section.

10. The method of claim 8, wherein the adversarial generator prompt template refinement process further comprises an evolutionary prompt template optimization process, the evolutionary prompt template optimization process comprising:
initializing an initial population of one or more reproduced generator prompt templates within the LLM-based reproducer, wherein the initial population of one or more reproduced generator prompt templates is generated from the generator prompt template, and wherein each reproduced generator prompt template of the initial population includes one or more mutations;
generating within the LLM-based generator from the initial population of one or more reproduced generator prompt templates, one or more generated responses, wherein each generated response of the one or more generated responses corresponds to each reproduced generator prompt template of the one or more reproduced generator prompt templates;
generating a judgment indicator within the LLM-based judger for each generated response the one or more generated response;
comparing each judgment indicator against the configurable threshold value;
selecting one or more reproduced generator prompt templates corresponding to the one or more generated responses having an improved judgment indicators; and
creating one or more generations of one or more reproduced generator prompt templates until a judgment indicator is equal to or lesser than the configurable threshold value.

11. The method of claim 10, wherein the creating of each generation of the one or more generations comprises repeating a series of operations, the series of operations comprising:
reproducing the selected one or more reproduced generator prompt templates, wherein each reproduced generator prompt template of one or more reproduced generator prompt templates includes a one or more mutations;
generating the judgment indicator for each reproduced generator prompt template of the one or more reproduced generator prompt templates, wherein each judgment indicator is based on at least the generated response for each reproduced generator prompt template;
selecting one or more reproduced generator prompt templates having an improved judgment indicator;
comparing the judgment indicator against the configurable threshold value; and
based on at least the comparison, terminating the series of operations when the judgment indicator for a generated response is equal to or lesser than the configurable threshold value;
selecting a generated response having the judgment indicator equal to or lesser than the configurable threshold value; and
outputting the final generator prompt template, wherein the final generator prompt template is the selected generated response.

12. The method of claim 11, wherein each mutation of the one or more mutations comprise at least one unique mutation.

13. The method of claim 11, wherein creating each generation of the one or more generations of reproduced generator prompts further comprises:
terminating the series of operations after a configurable number of generations;
selecting a generated response having an improved judgment indicator; and
outputting the final generator prompt template, wherein the final generator prompt template is the reproduced generator prompt template corresponding to the selected generated response.

14. The method of claim 11, wherein creating each generation of the one or more generations of reproduced generator prompts further comprises:
organizing the one or more reproduced generator prompt templates into pairs; and
exchanging an attribute between each reproduced generator prompt template of each pair.

15. A method for LLM hallucination reduction, comprising:
receiving a generator prompt template of a user from a computing device as an input to a Large Language Model (LLM), wherein the generator prompt template includes at least a generator prompt reference section, and wherein the LLM comprises an LLM-based adversarial prompt refiner configured to generate a final generator prompt template using an adversarial generator prompt template refinement process, the adversarial generator prompt template refinement process comprising:
generating within an LLM-based generator, one or more generated responses from the generator prompt template or reproduced generator prompt templates;
generating within an LLM-based judger, a judgment indicator indicating a presence or an absence of one or more hallucinations for each generated response of the one or more generated responses;
comparing within the LLM-based judger, each judgement indicator with a configurable threshold value;
deploying from the LLM-based judger, the final generator prompt template, wherein the final generator prompt template is based on at least the generator prompt template or reproduced generator prompt template corresponding to the generated response of the one or more generated responses having the judgment indicator lesser than or equal to the configurable threshold value; and
generating one or more reproduced generator prompt templates, within an LLM-based reproducer, in response to the judgement indicator comparison wherein each reproduced generator prompt template of one or more reproduced generator prompt templates includes a one or more mutations.

16. The method of claim 15, wherein evaluating each generated response of the one or more generated responses for one or more hallucinations within the LLM-based judger comprises:
accepting as inputs at the LLM-based judger, the generated response, and the generator prompt reference section;
generating a judger instance from the inputs and a judger prompt template; and
generating from the judger instance, a judgment indicator, and a judgment explanation, wherein the judgment indicator indicates a presence or an absence of one or more hallucinations in the generated response, wherein the judgment explanation indicates how the LLM-based judger determined whether the generated response included a hallucination, and wherein the judgment explanation is based on at least the generator prompt reference section.

17. The method of claim 15, wherein the adversarial generator prompt template refinement process further comprises an evolutionary prompt template optimization process, the evolutionary prompt template optimization process comprising:
initializing an initial population of one or more reproduced generator prompt templates within the LLM-based reproducer, wherein the initial population of one or more reproduced generator prompt templates is generated from the generator prompt template, wherein each reproduced generator prompt template of the initial population includes one or more mutations and wherein each mutation of the one or more mutations comprise at least one unique mutation;
generating within the LLM-based generator from the initial population of one or more reproduced generator prompt templates, one or more generated responses, wherein each generated response of the one or more generated responses corresponds to each reproduced generator prompt template of the one or more reproduced generator prompt templates;
generating a judgment indicator within the LLM-based judger for each generated response the one or more generated response;
comparing each judgment indicator against the configurable threshold value;
selecting one or more reproduced generator prompt templates corresponding to the one or more generated responses having an improved judgment indicators; and
creating one or more generations of one or more reproduced generator prompt templates until a judgment indicator is equal to or lesser than the configurable threshold value.

18. The method of claim 17, wherein the creating of each generation of the one or more generations comprises repeating a series of operations, the series of operations comprising:
reproducing the selected one or more reproduced generator prompt templates, wherein each reproduced generator prompt template of one or more reproduced generator prompt templates includes a one or more mutations, and wherein each mutation of the one or more mutations comprise at least one unique mutation;
generating the judgment indicator for each reproduced generator prompt template of the one or more reproduced generator prompt templates, wherein each judgment indicator is based on at least the generated response for each reproduced generator prompt template;
selecting one or more reproduced generator prompt templates having an improved judgment indicator;
comparing the judgment indicator against the configurable threshold value; and
based on at least the comparison, terminating the series of operations when the judgment indicator for a generated response is equal to or lesser than the configurable threshold value;
selecting a generated response having the judgment indicator equal to or lesser than the configurable threshold value; and
outputting the final generator prompt template, wherein the final generator prompt template is the selected generated response.

19. The method of claim 18, wherein creating each generation of the one or more generations of reproduced generator prompts further comprises:
terminating the series of operations after a configurable number of generations;
selecting a generated response having an improved judgment indicator; and
outputting the final generator prompt template, wherein the final generator prompt template is the reproduced generator prompt template corresponding to the selected generated response.

20. The method of claim 15, wherein creating each generation of the one or more generations of reproduced generator prompts further comprises:
organizing the one or more reproduced generator prompt templates into pairs; and
exchanging an attribute between each reproduced generator prompt template of each pair.
